(19) United States
(12) Patent Application Publication
(10) Pub. No.: US 2019/0095847 A1
(43) Pub. Date: Mar. 28, 2019

(54) SYSTEM AND METHOD FOR MONITORING WORKFLOW CHECKLIST WITH AN UNOBTRUSIVE SENSOR

(71) Applicant: HONEYWELL INTERNATIONAL INC., Morris Plains, NJ (US)

(72) Inventors: Kiran Gopala Krishna, Bangalore (IN); Christopher Douglas Eick, Phoenix, AZ (US); Ramdas Pai, Morristown, NJ (US)

(73) Assignee: HONEYWELL INTERNATIONAL INC., Morris Plains, NJ (US)

(21) Appl. No.: 15/994,121

(22) Filed: May 31, 2018

(30) Foreign Application Priority Data
Sep. 28, 2017 (IN) 201711034604

(51) Int. Cl. G06Q 10/06; B64D 45/00

(52) U.S. Cl. CPC G06Q 10/063114; B64D 2045/0075; B64D 45/00

(57) ABSTRACT

Methods and systems are provided for monitoring the completion of a workflow checklist task. The apparatus comprises multiple sensors located in different points of an operational field space that is subject to the workflow checklist task. A synthetic sensing board that receives inputs from the plurality of sensors relating to the workflow checklist task. The synthetic sensing board has a core sensing circuit that processes the inputs and generates first order inferences about completion of the checklist task. It also assigns weighted values to each of the inputs and generates a second order inference about completion of the tasks based on summation of the weighted values of each input. A communications gateway transmits the first order and second order inferences about completion of the workflow checklist task to a display device.

### CROSS-REFERENCE TO RELATED APPLICATION(S)

This application claims priority from Indian Provisional Patent Application No. 201711034604, titled “Apparatus and Method for Monitoring Workflow Checklist with an Unobtrusive Sensor” that was filed Sep. 28, 2017.

### TECHNICAL FIELD

The present invention generally relates to aircraft operations, and more particularly relates to a system and method for monitoring a workflow checklist with an unobtrusive sensor.

### BACKGROUND

In many industries, the typical workflow is accomplished via a checklist to ensure proper execution of a procedure. In complex or demanding situations, the individual may not execute or improperly execute the right procedural steps due to miscommunications, distractions or other similar situations in a high workload environment. Hence, there is a need for a method and system to monitor the proper execution of a workflow checklist in an unobtrusive manner.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for monitoring the completion of a workflow checklist task. The apparatus comprises: a plurality of sensors located at different points in an operational field space that is subject to the workflow checklist task; a synthetic sensing board that receives inputs from the plurality of sensors relating to completion of the workflow checklist task, where the synthetic sensing board further comprises, a core sensing circuit that processes the inputs, generates first order inferences about completion of the workflow checklist task based on the sensor inputs, assigns weighted values to each of the inputs and generates a second order inference about completion of the workflow checklist task based on summation of the weighted values to each input, and a communications gateway that transmits the first order inferences and the second order inference about completion of the workflow checklist task; and a display device that receives and displays the first order inferences and the second order inference from the synthetic sensing board to a user of the workflow checklist.

A system is provided for monitoring the completion of a workflow checklist task. The apparatus comprises: a plurality of sensors located at different points in an operational field space that is subject to the workflow checklist task; a plurality of synthetic sensing boards located at corresponding points in the operational field space to the plurality of sensors, where each synthetic sensing board receives inputs from the plurality of sensors relating to completion of the workflow checklist task, where each synthetic sensing board further comprises, a core sensing circuit that processes the inputs, generates first order inferences about completion of the workflow checklist task based on the sensor inputs, assigns weighted values to each of the inputs and generates a second order inference about completion of the workflow checklist task based on summation of the weighted values to each input, and a communications gateway that transmits the first order inferences and the second order inference about completion of the workflow checklist task; and a display device that receives and displays the first order inferences and the second order inference from the plurality of synthetic sensing boards to a user of the workflow checklist.

A method is provided for monitoring the completion of a workflow checklist task. The method comprises: collecting inputs relating to the completion of a workflow checklist task with a plurality of sensors located in different points in an operational field space; transmitting the inputs relating to the completion of a workflow checklist task to a synthetic sensing board with a core sensing circuit; processing the inputs with the core sensing circuit to generate first order inferences about completion of the workflow checklist task based on the sensor inputs; assigning weighted values with the core sensing circuit to each of the inputs; generating a second order inference about completion of the workflow checklist tasks based on summation of the weighted values to each input; and transmitting the first order inferences and the second order inference about completion of the workflow checklist task with a communications gateway located on the synthetic sensing board to a display device.

Furthermore, other desirable features and characteristics of the systems and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a block diagram of a synthetic sensing board in accordance with one embodiment;

FIG. 2 shows a block diagram of series of synthetic sensing boards arranged in parallel in accordance with one embodiment;

FIG. 3 shows a detail block diagram of a synthetic sensing board in accordance with one embodiment; and

FIG. 4 shows a flowchart of a method for monitoring a workflow checklist with an unobtrusive sensor in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

An apparatus and method for monitoring a workflow checklist using an unobtrusive sensor has been developed. The system processes raw sensory data and derives first order and second order inferences about compliance with of workflow checklist. Embodiments may use co-hosted multiple sensors embedded in system circuitry to collect data and derive inferences concerning workstation status and workflow status. These monitors may advise and warn the operator of non-compliance with checklist procedures via multiple alert methods. Software algorithms and artificial intelligence (AI) models that reside in the embedded circuitry monitor the workflow checklist procedures and use decision logic to drive first-order hypothesis, second order hypothesis and higher order hypothesis for various applications using unobtrusive techniques. In the embodiments discussed, an aircraft and a checklist for use by an aircrew are discussed as an example. However, it should be understood that alternative embodiments could be applied to other non-aviation uses that require monitoring of checklists and related sensors.

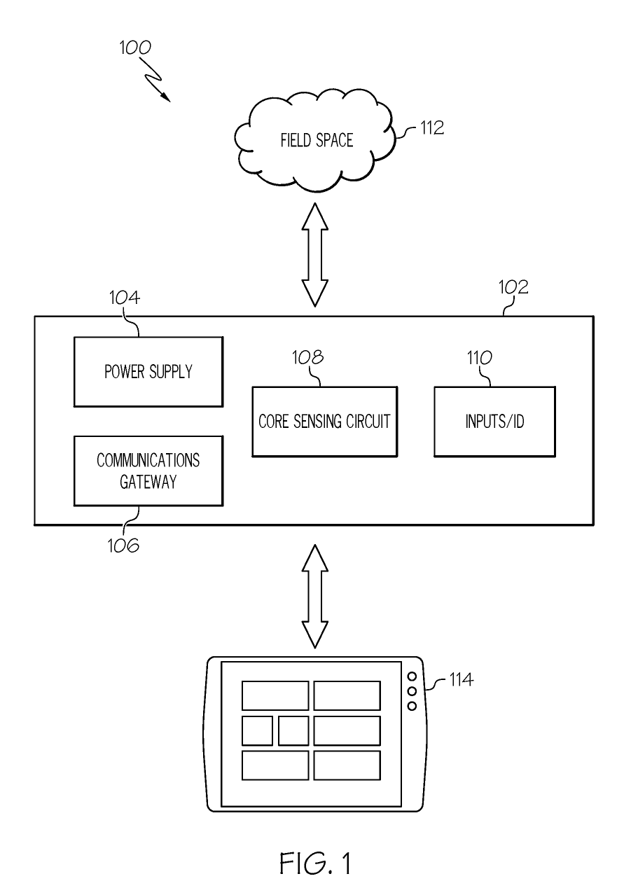

Some embodiments comprise a synthetic sensing board that is embedded in system circuitry that monitors the operator's workstation, environment and workflow. Turning now to FIG. 1, a block diagram 100 is shown of a synthetic sensing board 102 on board an aircraft in accordance with one embodiment. The synthetic sensing board 102 includes a separate power supply 104, an external communications gateway 106, a core sensing circuit 108 and an input/ID circuit 110. The synthetic sensing board 102 is installed so that it has access to field space 112 to receive and monitor inputs regarding its designated application and to communicate its generated inferences to an external display device 114. In alternative embodiments, the power supply may be external. In other embodiments, the communications gateway may be hardwired or use a wireless communications protocol such as Wi-Fi. In alternative embodiments, the external display device may be a tablet or electronic flight bag (EFB), an aural device such as a speaker or a radio that may communicate to an aircrew or outside the aircraft. The input/ID circuit provides the sensing board with a unique ID derived via strapped input pins or via software. It should also be noted that no physical connection is required to exist between the synthetic sensing circuit and the region of interest in the field space. In this embodiment, the synthetic sensing board is a local device that does not access or connect to the aircraft avionics bus. This provides an independent monitor of the status and compliance with the workflow checklist procedures without being subject to possible interference or failures of the avionics systems.

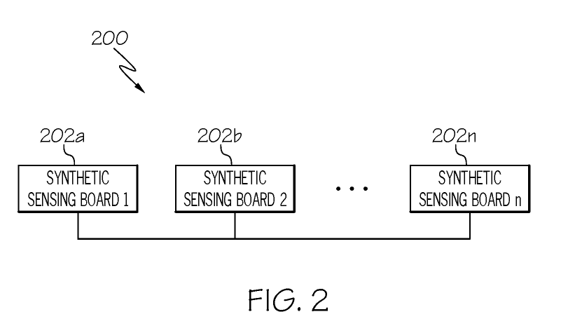

Turning now to FIG. 2 a block diagram 200 of a series of synthetic sensing boards 202a-202n is shown in accordance with one embodiment. Multiple synthetic sensing boards may be used to monitor field space at various distinct points in the aircraft. The multiple sensing boards are placed across various locations in the aircraft to increase sensing accuracy. For example, one synthetic sensing board may be configured to sense vibrations and installed near the undercarriage of the aircraft while a second synthetic sensing board may be located with an optical sensor in the cockpit near the landing gear lever to monitor the lever position. The multiple sensing boards may be connected to a common network via wired or wireless communications protocol. In this example, both synthetic sensing board/sensor pairs may be used to monitor the position of the aircraft landing gear which is a checklist item for the aircrew at various phases of flight operations.

In these examples, the synthetic sensing boards may be used in aircraft operations to monitor the performance of workflow checklists by the aircrew. The sensors for the synthetic sensing board may include: optical sensors such as an infrared (IR) sensor; acoustic sensors such as a microphone; vibration sensors; temperature sensors; pressure sensors; position/location sensors such as a global positioning system (GPS) sensor; acceleration sensors; altitude sensors; and orientation sensors such as gyroscopes and accelerometers. The objective of the synthetic sensing board is to monitor various components and regions of the aircraft to get a more complete picture of the status of the aircraft and compliance with the workflow checklist.

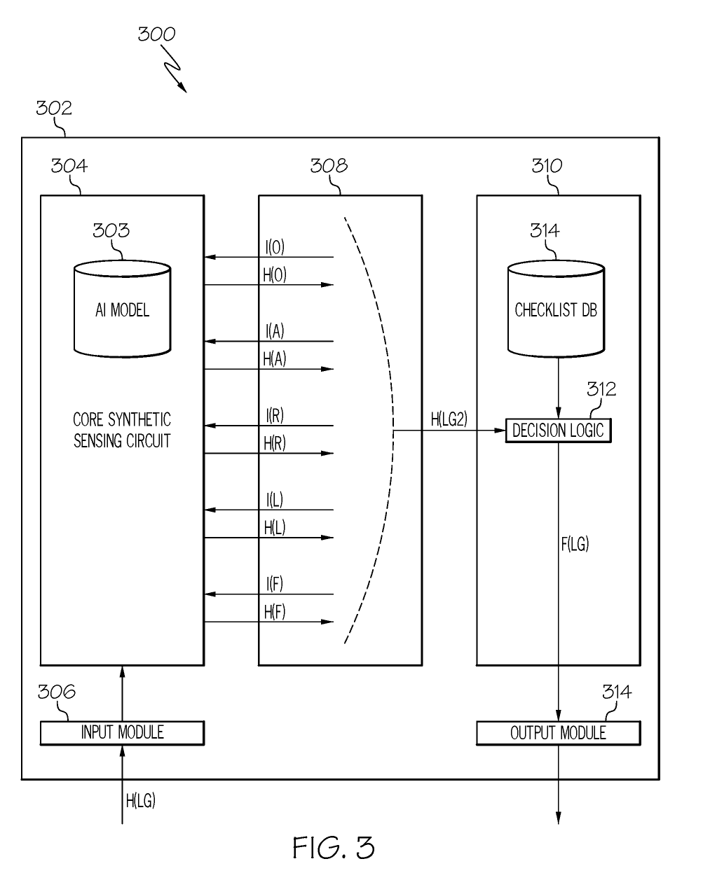

Turning now to FIG. 3, a detailed block diagram 300 of a synthetic sensing board 302 for an aircraft is shown in accordance with one embodiment. In this embodiment, the synthetic sensing board is used to monitor compliance with the landing gear retraction task on a workflow checklist for an aircraft. It should be understood that while this example is directed towards the sensing of the retraction of the landing gear of an aircraft, that other workflow checklist tasks could be monitored with a similar protocol using similar synthetic sensing boards.

In this embodiment, and artificial intelligence (AI) model 303 is first loaded into the core synthetic sensing circuit 304 of the synthetic sensing board 302. This AI model 303 contains the logic for determining the hypotheses related to the retraction of the landing gear of the aircraft. The core synthetic sensing circuit 304 receives sensor information from multiple channels of onboard sensors located at various points throughout the aircraft. This raw sensor data is processed and represented as appropriate vectors that are fed into the AI model. The AI model derives both first-order 308 and second order 310 hypotheses based on inferences from each sensing channel.

In operation of this embodiment, the input module 306 of the synthetic sensing board 302 receives a tasking to confirm landing gear retracts status H(LG). The tasking is passed to the core synthetic sensing circuit 304 which receives and processes raw sensor data. In this embodiment, the first-order hypotheses 308 for the landing gear H(LG) is calculated from sensor channel input related to: landing gear lever position; retraction sound of the landing gear; positive rate of climb and vibrations; and location and altitude.

In this example, the input from an optical sensor I(O) such as a camera in the cockpit is received and a hypothesis regarding the landing gear lever position H(O) is derived. Input from an acoustic sensor I(A) such as a microphone near the landing wheel well is received and a hypothesis regarding the retraction of the landing gear based on sensing of the sounds is derived H(A). Signal input from an accelerometer and a gyroscope is received I(R) and a hypothesis regarding the rate of climb in vibrations is derived H(R). By way of example, the rate of climb hypotheses H(R) may be shared among multiple synthetic sensing boards that monitor compliance with other checklist procedures that may need to utilize this information. Input from a Global Positioning System (GPS) receiver and altitude sensor I(L) is received and a hypothesis regarding the location and altitude of the aircraft is derived H(L). It should be understood that other sensors could provide inputs I(F) that may be used to derive other hypotheses H(F) as needed for use by the synthetic sensing board 302.

Each of these hypotheses are fed into the AI model 303 to derive separate inferences or “first-order hypotheses” from each sensing channel. In this example, the accelerometer may sense the vibration and drag of the aircraft. The optical camera may recognize the position of switches, levers and knobs in the cockpit. The acoustic sensor or microphone may track clicks, presses of buttons, knobs and levers. The GPS/accelerometer tracks the position and orientation of the aircraft. The first-order hypotheses are each separate and distinct inferences based on the input from each separate sensor.

A “second order hypotheses” H(LG2) 310 is generated to determine the actual detection of whether the landing gear is extended or retracted. The second order hypothesis combines the inferences of the first-order hypotheses to make a more clear and definite determination of the landing gear position. In this example, the second-order landing gear Hypothesis (HLG2) may be derived as:

H_{LG2}=a₁Hₒ+a₂Hd_{A}+a₃H_{R}+a₄H_{L}+a₅H_{F}

where “H” denotes the specific hypotheses and “a” denotes the assigned weight to that hypotheses. A generic form of the second order hypothesis derivation formula is:

Hₒₙ=ΣaᵢⱼHᵢⱼ

The value of each weight assigned to a sensor is based on confidence in that sensor, environmental conditions affecting the sensor, and other scenario conditions. The weights assigned to each sensor may vary over time depending on these factors. For example, the weight assigned to an optical sensor on an exterior part of the aircraft may vary according to visibility conditions. The AI model may make these adjustments to the weighted values assigned to each hypothesis over time.

Once the second-order landing gear hypothesis H(LG2) is generated, it is provided to a decision logic circuit 312 that references a workflow checklist database 314. The decision logic analyzes the hypothesis H(LG2) to generate a finding of the status of the landing gear F(LG). The finding F(LG) is provided to an output module 314 for transmission to the aircrew. This finding may provide a real-time warning of noncompliance to the checklist parameters to the aircrew.

Examples of checklist tasks used by an aircrew that may be monitored in some embodiments include: Pre-Start tasks; after Start/Taxi tasks; Pre-Takeoff/Hold Short tasks; After Takeoff/Climb tasks; Final Approach tasks; After Landing/Taxi tasks; Parking tasks and Shutdown tasks. Pre-Start tasks may include: confirmation of a pre-start briefing; brakes on; throttle idle; spoilers off; flaps retracted; seatbelts on; no smoking on; navigation lights off; beacon lights on; landing lights off; strobe lights off; flight plan completed; rudder/aileron tested; and cruising speed set. After Start/Taxi tasks may include: pushback/taxi clearance received; seatbelts on; no smoking on; navigation lights on; take off flaps set; brakes off; and forward thrust set. Pre-Takeoff/Hold Short tasks may include: confirmation of pre-takeoff briefing; landing lights on; strobe lights on; take off flaps checked; flight controls checked; and cabin ready. After Takeoff/Climb tasks may include: landing gear up; flaps retracted; A/P engaged; landing lights off; seatbelts off; and no smoking on. Parking tasks may include: brakes on; engines shutoff; seatbelts off; and no smoking on. Shutdown tasks may include: brakes on; throttle idle; flaps retracted; spoilers off; landing lights off; strobe lights off; navigation lights off; A/P preferences clear; no trim; flight plan clear; and beacon lights off.

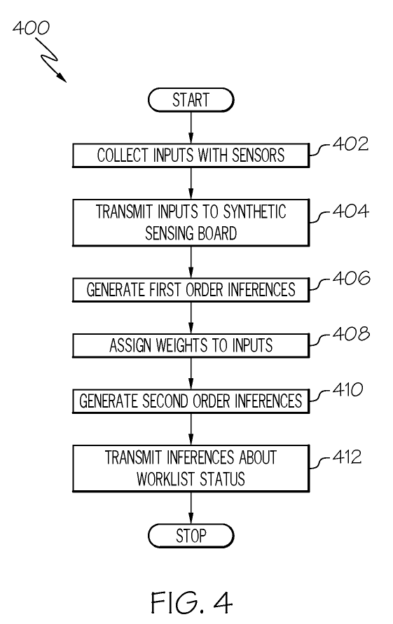

Turning now to FIG. 4, a flowchart 400 is shown for a method for monitoring the completion of a workflow checklist task in accordance with some embodiments. First, a plurality of sensors collects inputs from different points of an operational field space that is subject to a workflow checklist task 402. The inputs collected from the sensors are transmitted to a synthetic sensing board 404. The sensing board processes the sensor inputs with a core sensing circuit to generate first order inferences about the completion of the workflow checklist task 406. Next, weighted values are assigned to each input 408 and the weighted inputs are used to generate second order inferences about the completion of the workflow checklist tasks based on summation of the weighted values 410. The first order inferences and second order inferences about the workflow checklist tasks are then transmitted to a display device 412 for the user of the workflow checklist.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for monitoring the completion of a workflow checklist task, comprising:
a plurality of sensors located at different points in an operational field space that is subject to the workflow checklist task;
a synthetic sensing board that receives inputs from the plurality of sensors relating to completion of the workflow checklist task, where the synthetic sensing board further comprises,
a core sensing circuit that processes the inputs, generates first order inferences about completion of the workflow checklist task based on the sensor inputs, assigns weighted values to each of the inputs and generates a second order inference about completion of the workflow checklist task based on summation of the weighted values to each input, and
a communications gateway that transmits the first order inferences and the second order inference about completion of the workflow checklist task; and
a display device that receives and displays the first order inferences and the second order inference from the synthetic sensing board to a user of the workflow checklist.

2. The system of claim 1, where the plurality of sensors comprise optical sensors.

3. The system of claim 1, where the plurality of sensors comprise acoustic sensors.

4. The system of claim 1, where the plurality of sensors comprise vibration sensors.

5. The system of claim 1, where the plurality of sensors comprise temperature sensors.

6. The system of claim 1, where the plurality of sensors comprise pressure sensors.

7. The system of claim 1, where the plurality of sensors comprise position sensors.

8. The system of claim 1, where the plurality of sensors comprise altitude sensors.

9. The system of claim 1, where the plurality of sensors comprise orientation sensors.

10. The system of claim 1, where the plurality of sensors comprise acceleration sensors.

11. The system of claim 1, where the synthetic sensing board further comprises:
an input/identification (ID) circuit that receives and identifies inputs from the plurality of sensors; and
a power supply for the synthetic sensing board.

12. The system of claim 11, where the power supply is external to the synthetic sensing board.

13. The system of claim 11, where the power supply is internal to the synthetic sensing board.

14. The system of claim 1, where the weighted value assigned to the input from each sensor is weighted based on a value reflecting confidence in that sensor.

15. The system of claim 1, where the weighted value assigned to the input from each sensor is weighted based on environmental conditions affecting that sensor.

16. The system of claim 1, where the weighted value assigned to the input from each sensor is variable.

17. The system of claim 1, where the synthetic sensing board receives inputs from the plurality of sensors via a wireless communications link.

18. The system of claim 1, where the communications gateway transmits the first order inferences and the second order inference via a wireless communications link.

19. A system for monitoring the completion of a workflow checklist task, comprising:
a plurality of sensors located at different points in an operational field space that is subject to the workflow checklist task;
a plurality of synthetic sensing boards located at corresponding points in the operational field space to the plurality of sensors, where each synthetic sensing board receives inputs from the plurality of sensors relating to completion of the workflow checklist task, where each synthetic sensing board further comprises,
a core sensing circuit that processes the inputs, generates first order inferences about completion of the workflow checklist task based on the sensor inputs, assigns weighted values to each of the inputs and generates a second order inference about completion of the workflow checklist task based on summation of the weighted values to each input, and
a communications gateway that transmits the first order inferences and the second order inference about completion of the workflow checklist task; and
a display device that receives and displays the first order inferences and the second order inference from the plurality of synthetic sensing boards to a user of the workflow checklist.

20. A method for monitoring the completion of a workflow checklist task, comprising:
collecting inputs relating to the completion of a workflow checklist task with a plurality of sensors located at different points in an operational field space;
transmitting the inputs relating to the completion of the workflow checklist task to a synthetic sensing board with a core sensing circuit;
processing the inputs with the core sensing circuit to generate first order inferences about completion of the workflow checklist task based on the sensor inputs;
assigning weighted values with the core sensing circuit to each of the inputs;
generating a second order inference about completion of the workflow checklist tasks based on summation of the weighted values to each input; and
transmitting the first order inferences and the second order inference about completion of the workflow checklist task with a communications gateway located on the synthetic sensing board to a display device.
